(19) United States
(12) Patent Application Publication
(10) Pub. No.: US 2025/0067355 A1
(43) Pub. Date: Feb. 27, 2025

(54) Tide Gate Check Valve with an Enlarged Integral Annular Wall

(71) Applicant: Red Valve Company, Inc., Pittsburgh, PA (US)

(72) Inventor: Michael J. Duer, Zelienople, PA (US)

(21) Appl. No.: 18/726,178

(22) PCT Filed: Jan. 6, 2023
(86) PCT No.: PCT/US23/10262

§ 371 Date: Jul. 2, 2024

Related U.S. Application Data
(60) Provisional application No. 63/297,016, filed on Jan. 6, 2022.

(51) Int. Cl. F16K 15/14; E03F 7/04

(52) U.S. Cl. CPC F16K 15/147; E03F 7/04

(57) ABSTRACT

A check valve that includes: (a) a tubular valve body having a downstream end and an upstream end and (b) a tubular sleeve positioned within the valve body. The tubular sleeve bounds a longitudinally-extending flow-through passage for fluids, and has an upstream fluid inlet region and a downstream fluid outlet region. The downstream end or upstream end of the tubular valve body includes an enlarged integral annular wall thickness having an outside diameter that is greater than the outside diameter of the remaining portions of the tubular valve body. The enlarged integral annular wall thickness is configured to compress against and form a leak tight seal with a first or second end of a receiving conduit, and the remaining portions of the tubular valve body are configured to extend into the receiving conduit.

### CROSS REFERENCE TO RELATED APPLICATION

This application claims priority to U.S. Provisional Patent Application No. 63/297,016 filed Jan. 6, 2022, the disclosure of which is hereby incorporated by reference in its entirety.

### BACKGROUND OF THE INVENTION

### Field of the Invention

This invention generally relates to check valves and, in particular, to tide gate valves having an enlarged integral annular wall for forming leak tight seals with a conduit.

### Description of Related Art

A check valve is essentially a valve which allows fluid flow in only one direction through a conduit, while closing and preventing back or reverse flow when back pressure builds up downstream of the valve to a level greater than the upstream fluid pressure head. Examples of tide gate type check valves are described in U.S. Pat. Nos. 5,769,125 and 10,550,954, which are incorporated by reference in their entireties.

The check valve is typically installed by inserting the valve into a mating conduit and using expansion clamps to expand to the check valve body firmly against the conduit inside diameter. However, it is necessary to precisely control the outside diameter of the check valve and the inside diameter of the mating conduit to ensure that the valve is loose enough to slide into the conduit, but not so loose as to prevent the valve body from expanding to grip the inside diameter of the mating conduit. Because these physical specifications must be precise, the cost to manufacture the check valve is expensive, and the installation process to insert the valve in the conduit can be time consuming.

Thus, it is desirable to provide an improved tide gate check valve that allows for a greater dimensional tolerance to the outside diameter of the valve body, inside diameter of the mating conduit, or both, thereby reducing manufacturing cost and allowing for an easier installation process.

### SUMMARY OF THE INVENTION

In certain non-limiting embodiments, the present invention includes a check valve comprising: (a) a tubular valve body comprising a downstream end and an upstream end; and (b) a tubular sleeve positioned within the valve body, the tubular sleeve bounding a longitudinally-extending flow-through passage for fluids, the sleeve having an upstream fluid inlet region and a downstream fluid outlet region. The downstream end or upstream end of the tubular valve body comprises an enlarged integral annular wall thickness having an outside diameter that is greater than the outside diameter of the remaining portions of the tubular valve body. The enlarged integral annular wall thickness is configured to compress against and form a leak tight seal with a first or second end of a receiving conduit, and the remaining portions of the tubular valve body are configured to extend into the receiving conduit.

The enlarged integral annular wall thickness can also have an inclined or angled shape on the inside portion that is configured to compress against and form the leak tight seal with the first or second end of the receiving conduit. Moreover, the remaining portions of the tubular valve body extending from the enlarged integral annular wall thickness can have an outside diameter that is sized to form an annular gap between the tubular valve body and the receiving conduit.

In certain non-limiting embodiments, the check valve further comprises a clamping apparatus that secures the check valve to a separate component or area. The clamping apparatus can comprise, for example, one or more brackets having a first end that attaches to the tubular valve body and a second end that is secured to the separate component or area.

In some non-limiting embodiments, the downstream fluid outlet region of the sleeve is integrally formed with a longitudinally-extending trough. The trough has a bottom wall and a pair of side walls integral with the bottom wall. The trough is formed with the downstream fluid outlet region of the sleeve, so as to provide a flow-through passage.

The check valve can also include a disc comprising a first material affixed along a first portion of its periphery to a flexible hinge member. The flexible hinge member is affixed to and interposed between the disc and the downstream fluid outlet region of the sleeve. A second portion of the periphery of the disc, opposite the first portion, rests within the trough on the bottom wall of the trough when the valve is in a closed position. Further, the disc opens the valve in response to positive differential pressure within the valve.

The check valve can further comprise a bill affixed at a first end to one or more of the sleeve, the flexible hinge member, and the disc. The bill extends longitudinally downstream along the longitudinal axis of the trough, and is integrally formed with said side walls of said trough. The bill can be formed of a flexible material, and forms an opening for discharge of fluid in response to a positive differential pressure within the valve from the fluid. The bill forms a seal to prevent backflow of the fluid through said valve when no differential pressure or negative differential pressure is present.

The present invention also includes a fluid control system comprising: (1) a check valve, and (2) a receiving conduit. The check valve can comprise: (a) a tubular valve body comprising a downstream end and an upstream end, and (b) a tubular sleeve positioned within the valve body, the tubular sleeve bounding a longitudinally-extending flow-through passage for fluids, the sleeve having an upstream fluid inlet region and a downstream fluid outlet region. The downstream end or upstream end of the tubular valve body comprises an enlarged integral annular wall thickness having an outside diameter that is greater than the outside diameter of the remaining portions of the tubular valve body. Further, the enlarged integral annular wall thickness of the tubular valve body has an outside diameter that is greater than at least an inside diameter of the receiving conduit, and the remaining portions of the tubular valve body extending from the enlarged integral annular wall thickness have an outside diameter that is less than the inside diameter of the receiving conduit. The enlarged integral annular wall thickness of the tubular valve body is compressed against and forms a leak tight seal with a first or second end of the receiving conduit, and the remaining portions of the tubular valve body extend into the receiving conduit.

In certain non-limiting embodiments, the enlarged integral annular wall thickness has an inclined or angled shape on the inside portion that compresses against and forms the leak tight seal with the first or second end of the receiving conduit. An annular gap can be formed between the receiving conduit and the remaining portions of the tubular valve body extending into the receiving conduit.

In some non-limiting embodiments, a clamping apparatus secures the check valve to a separate component or area. The clamping apparatus can comprise one or more brackets having a first end that is attached to the tubular valve body and a second end that is secured to the separate component or area.

The check valve can further include any of the components, features, and configurations previously described and which are further described herein, such as the disc, trough, and bill.

In some non-limiting embodiments, the present invention includes a check valve assembly comprising: (i) any one of the previously described check valves and (ii) a clamping apparatus that secures the check valve to a separate component or area.

In certain non-limiting embodiments, the present invention includes a method of forming a fluid a control system comprising: (i) inserting a check valve into a receiving conduit, the check valve comprising any one of the previously described check valves and which are further described herein and (ii) compressing the enlarged integral annular wall thickness of the tubular valve body against a first or second end of the receiving conduit to form a leak tight seal, in which the remaining portions of the tubular valve body extend into the receiving conduit. The method can also include securing the check valve to a separate component or area with a clamping apparatus. The clamping apparatus can comprise one or more brackets as previously described having a first end that is attached to the tubular valve body and a second end that is secured to the separate component or area.

The present invention also includes the following clauses:

Clause 1: A check valve comprising: (a) a tubular valve body comprising a downstream end and an upstream end and (b) a tubular sleeve positioned within the valve body, the tubular sleeve bounding a longitudinally-extending flow-through passage for fluids, said sleeve having an upstream fluid inlet region and a downstream fluid outlet region, wherein the downstream end or upstream end of the tubular valve body comprises an enlarged integral annular wall thickness having an outside diameter that is greater than the outside diameter of the remaining portions of the tubular valve body.

Clause 2: The check valve according to clause 1, wherein the enlarged integral annular wall thickness is configured to compress against and form a leak tight seal with a first or second end of a receiving conduit, and the remaining portions of the tubular valve body are configured to extend into the receiving conduit.

Clause 3: The check valve according to any one of clauses 1 and 2, wherein the enlarged integral annular wall thickness has an inclined or angled shape on the inside portion.

Clause 4: The check valve according to any one of the preceding clauses, wherein the remaining portions of the tubular valve body extending from the enlarged integral annular wall thickness have an outside diameter that is sized to form an annular gap between the tubular valve body and the receiving conduit.

Clause 5: The check valve according to any one of the preceding clauses, further comprising a clamping apparatus that secures the check valve to a separate component or area.

Clause 6: The check valve according to clause 5, wherein the clamping apparatus comprises one or more brackets having a first end that is attached to the tubular valve body and a second end that is secured to the separate component or area.

Clause 7: The check valve according to any one of the preceding clauses, wherein the downstream fluid outlet region of said sleeve is integrally formed with a longitudinally-extending trough, said trough having a bottom wall and a pair of side walls integral with said bottom wall, said trough formed with said downstream fluid outlet region of said sleeve so as to provide a flow-through passage.

Clause 8: The check valve according to clause 7, further comprising a disc comprising a first material affixed along a first portion of its periphery to a flexible hinge member, said flexible hinge member affixed to and interposed between said disc and said downstream fluid outlet region of said sleeve, and wherein a second portion of the periphery of said disc opposite said first portion rests within said trough on said bottom wall of said trough when said valve is in a closed position, wherein said disc opens said valve in response to positive differential pressure within said valve.

Clause 9: The check valve according to clause 8, further comprising a bill affixed at a first end to one or more of the group consisting of the sleeve, the flexible hinge member, and the disc, said bill extending longitudinally downstream along said longitudinal axis of said trough, said bill being integrally formed with said side walls of said trough, said bill being formed of a flexible material and forming an opening for discharge of fluid in response to a positive differential pressure within said valve from said fluid, and said bill forming a seal to prevent backflow of said fluid through said valve when no differential pressure or negative differential pressure is present.

Clause 10: The check valve according to any one of the preceding clauses, wherein the downstream end of the tubular valve body comprises the enlarged integral annular wall thickness.

Clause 11: A fluid control system comprising: (1) a check valve comprising: (a) a tubular valve body comprising a downstream end and an upstream end, and (b) a tubular sleeve positioned within the valve body, the tubular sleeve bounding a longitudinally-extending flow-through passage for fluids, said sleeve having an upstream fluid inlet region and a downstream fluid outlet region, wherein the downstream end or upstream end of the tubular valve body comprises an enlarged integral annular wall thickness having an outside diameter that is greater than the outside diameter of the remaining portions of the tubular valve body; and (2) a receiving conduit, wherein the enlarged integral annular wall thickness of the tubular valve body has an outside diameter that is greater than at least an inside diameter of the receiving conduit, and the remaining portions of the tubular valve body extending from the enlarged integral annular wall thickness have an outside diameter that is less than the inside diameter of the receiving conduit, and wherein the enlarged integral annular wall thickness of the tubular valve body is compressed against and forms a leak tight seal with a first or second end of the receiving conduit, and the remaining portions of the tubular valve body extend into the receiving conduit.

Clause 12: The fluid control system according to clause 11, wherein the enlarged integral annular wall thickness has an inclined or angled shape on the inside portion that compresses against and forms the leak tight seal with the first or second end of the receiving conduit.

Clause 13: The fluid control system according to any one of clauses 11 and 12, wherein an annular gap is formed between the receiving conduit and the remaining portions of the tubular valve body extending into the receiving conduit.

Clause 14: The fluid control system according to any one of clauses 11 through 13, further comprising a clamping apparatus that secures the check valve to a separate component or area.

Clause 15: The fluid control system according any one of clauses 11 through 14, wherein the clamping apparatus comprises one or more brackets having a first end that is attached to the tubular valve body and a second end that is secured to the separate component or area.

Clause 16: The fluid control system according to any one of clauses 11 through 15, wherein the downstream fluid outlet region of said sleeve is integrally formed with a longitudinally-extending trough, said trough having a bottom wall and a pair of side walls integral with said bottom wall, said trough formed with said downstream fluid outlet region of said sleeve so as to provide a flow-through passage.

Clause 17: The fluid control system according to clause 16, where the check valve further comprises a disc comprising a first material affixed along a first portion of its periphery to a flexible hinge member, said flexible hinge member affixed to and interposed between said disc and said downstream fluid outlet region of said sleeve, and wherein a second portion of the periphery of said disc opposite said first portion rests within said trough on said bottom wall of said trough when said valve is in a closed position, wherein said disc opens said valve in response to positive differential pressure within said valve, and a bill affixed at a first end to one or more of the group consisting of the sleeve, the flexible hinge member, and the disc, said bill extending longitudinally downstream along said longitudinal axis of said trough, said bill being integrally formed with said side walls of said trough, said bill being formed of a flexible material and forming an opening for discharge of fluid in response to a positive differential pressure within said valve from said fluid, and said bill forming a seal to prevent backflow of said fluid through said valve when no differential pressure or negative differential pressure is present.

Clause 18: A check valve assembly comprising: (i) a check valve according to any one of clauses 1 through 10 and (ii) a clamping apparatus that secures the check valve to a separate component or area.

Clause 19: A method of forming a fluid control system comprising: (i) inserting a check valve into a receiving conduit, the check valve comprising: (a) a tubular valve body comprising a downstream end and an upstream end, and (b) a tubular sleeve positioned within the valve body, the tubular sleeve bounding a longitudinally-extending flow-through passage for fluids, said sleeve having an upstream fluid inlet region and a downstream fluid outlet region, wherein the downstream end or upstream end of the tubular valve body comprises enlarged integral annular wall thickness having an outside diameter that is greater than the outside diameter of the remaining portions of the tubular valve body; and (ii) compressing the enlarged integral annular wall thickness of the tubular valve body against a first or second end of the receiving conduit to form a leak tight seal, wherein the remaining portions of the tubular valve body extend into the receiving conduit.

Clause 20: The method according to clause 19, further comprising securing the check valve to a separate component or area with a clamping apparatus.

### BRIEF DESCRIPTION OF THE DRAWINGS

FIG. 1a is a front view from the downstream end of a check valve with the addition of an enlarged integral annular wall thickness at the downstream end of the valve body according to a non-limiting embodiment of the present invention;

FIG. 1b is a sectional side view of section B-B of FIG. 1;

FIG. 1c is a sectional top view of section A-A of FIG. 1;

FIG. 2 is a perspective sectional view of a check valve with the addition of an enlarged integral annular wall thickness at the downstream end of the valve body according to a non-limiting embodiment of the present invention;

FIG. 3 is a partial sectional side view of a check valve with the addition of an enlarged integral annular wall thickness at the downstream end of the valve body and which includes a clamping apparatus according to a non-limiting embodiment of the present invention; and

FIG. 4 is a front view from the downstream end of a check valve with the addition of an enlarged integral annular wall thickness at the downstream end of the valve body according to a non-limiting embodiment of the present invention.

### DESCRIPTION OF THE INVENTION

For the purpose of the following detailed description, it is to be understood that the invention may assume various alternative variations and step sequences, except where expressly specified to the contrary. Moreover, other than in any operating examples or where otherwise indicated, all numbers expressing, for example, quantities of ingredients used in the specification and claims are to be understood as being modified in all instances by the term “about”. Accordingly, unless indicated to the contrary, the numerical parameters set forth in the following specification and attached claims are approximations that may vary depending upon the desired properties to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard variation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

Further, the terms “upper,” “lower,” “right,” “left,” “vertical,” “horizontal,” “top,” “bottom,” “lateral,” “longitudinal,” and derivatives thereof shall relate to the invention as it is oriented in the drawing figures. However, it is to be understood that the invention may assume alternative variations and step sequences, except where expressly specified to the contrary. It is also to be understood that the specific devices and processes illustrated in the attached drawings, and described in the specification, are simply exemplary embodiments of the invention. Hence, specific dimensions and other physical characteristics related to the embodiments disclosed herein are not to be considered as limiting.

In this application, the use of the singular includes the plural and plurals encompasses the singular, unless specifically stated otherwise. In addition, in this application, the use of “or” means “and/or” unless specifically stated otherwise, even though “and/or” may be explicitly used in certain instances.

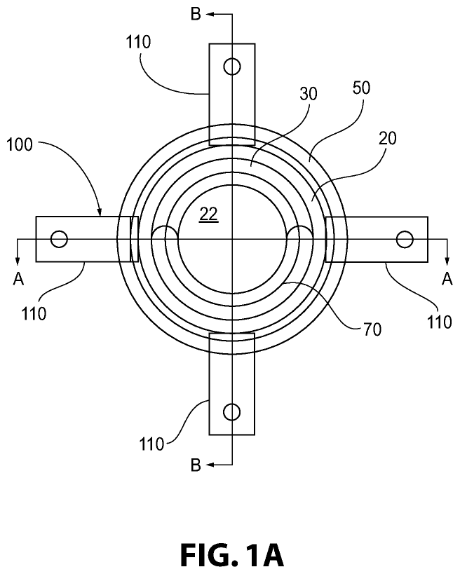

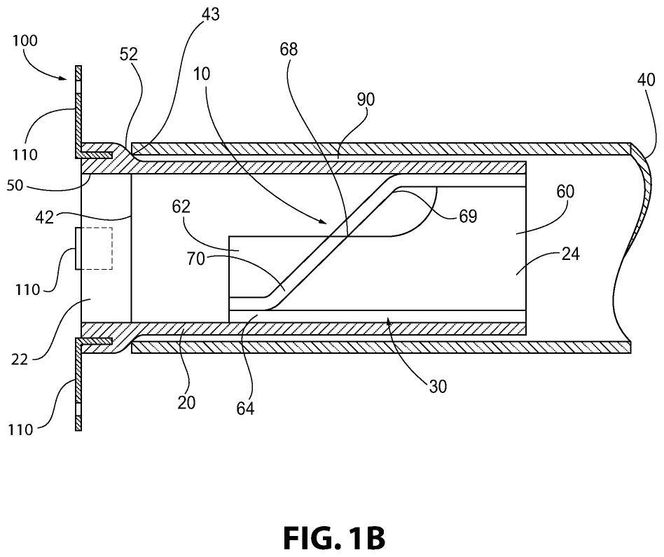

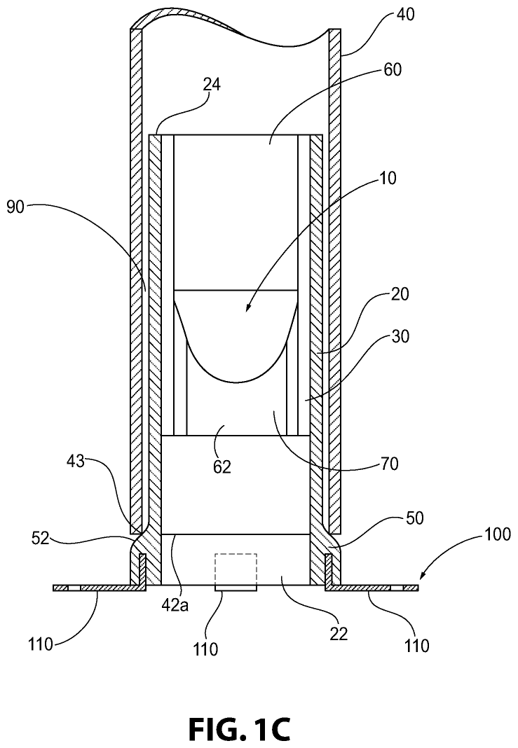

Referring to FIGS. 1a-1c, a check valve 10 according to the present invention generally comprises a valve body 20 and sleeve 30, which bounds a longitudinally-extending flow-through passage for the effluent fluid which maybe a gas, liquid, or slurry, such as raw sewage, storm rain water, sludge, chemical slurry, scum paper stock, tailings slurry, or any industrial waste. More specifically, the housing sleeve 30 has a generally tubular upstream fluid inlet region 60. Further, the sleeve 30 terminates at a second downstream end with a fluid outlet region 62 as shown in FIG. 1b.

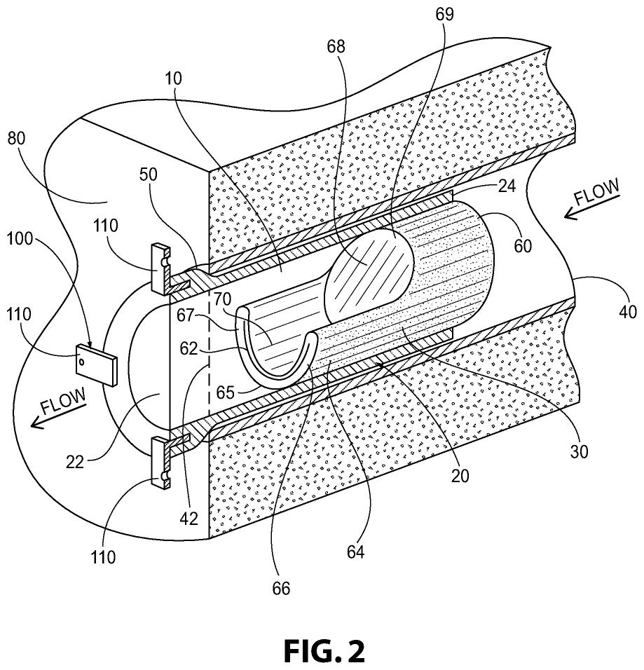

As indicated, the sleeve 30 terminates at a second downstream end with a fluid outlet region 62. Further, fluid outlet region 62 is integrally associated with a trough 64. The trough 64 is shown in FIGS. 1b and 2 as semi-cylindrical in design, but it is to be understood that it could be designed as a U-shaped or V-shaped channel or the like. While a semi-cylindrically shaped trough 64 typically does not include a pair of clearly defined side walls and a clearly defined bottom wall, conceptually, at least for the following discussion, it will be assumed that the semi-cylindrical shaped trough 64 is comprised of a bottom wall 65 and two side walls 66, 67, respectively.

The sleeve 30 and the trough 64 are formed of materials having sufficient strength to support the weight and pressure of effluent flowing through the valve 10. This material may take the form of one or more layers or plies of an elastomeric material with or without reinforcing fabric. When formed of an elastomeric material, or elastomeric material with reinforcing fabric, the material and the number and thickness of layers or plies are selected based upon the weight of effluent that will be traveling through the valve 10, so as to minimize sagging or distortion of the sleeve 30 or the trough 64. For most applications, a Shore A durometer of 65 to 95 will suffice.

The valve 10 can further include a disc 68 as shown in FIGS. 1b through 2. The disc 68 is composed of an elastomeric material, and is affixed to the fluid outlet region 62 of the sleeve 30 via a flexible member 69, which is in the nature of an elastomeric hinge. In one embodiment, the width of the disc 30 is coextensive with the distance between the side walls 66, 67 of the valve 10, thereby forming a seal against fluid from backflowing through the valve 10, with additional sealing being accomplished by the bill 70. The length of the disc 68 extending from the flexible member 69 to the bottom wall 65 of the trough 64 is longer than the interior diameter of the sleeve 30.

Referring to FIGS. 1a-1c and 2, the check valve 10 is enclosed in the integral tubular body 20, which in turn is installed in a conduit 40, such as a pipe. This check valve 10 provides a means to install the valve 10 and tubular body 20 inside a conduit 40, such as at the discharge end, without the necessity of having access to the upstream end of the valve 10, which in the case of small valves (less than 18 inches) is virtually impossible to do, and in the case of larger valves is inconvenient.

When the sleeve 30 is integral with a tubular body 20, the entire lower portion of the sleeve 30 below the plane of the horizontal centerline of the valve 10 can be vulcanized to the tubular body 20. Further, the portions of the sleeve 30 above the plane of the horizontal centerline of the valve 10 that are in contact with the tubular body 20 when the sleeve 30 is fully closed can also be vulcanized together. It is appreciated that the bill 70 and disc 68 are not vulcanized to the tubular body 20, and are free to move upward, allowing the sleeve 30 to open and discharge flow. As such, the bill 70 and disc 68 of the sleeve 30 are separated from the interior portions of the tubular body 20.

Other non-limiting features of a tide gate check-valve that can be used with the present invention are disclosed in U.S. Pat. Nos. 5,769,125 and 10,550,954, which are incorporated by reference herein in their entireties.

In accordance with certain non-limiting embodiments of the present invention, referring to FIGS. 1a-1c and 2, the downstream end 22 of the valve body 20 comprises an enlarged integral annular wall thickness 50 that is greater than the annular wall thickness of the other portions of the valve body 20. The enlarged integral annular wall thickness 50 of the downstream end 22 of the valve body 20 is enlarged to an extent that the integral annular wall thickness 50 has an outside diameter that is greater than at least the inside diameter of a receiving conduit 40. In some non-limiting embodiments, the enlarged integral annular wall thickness 50 of the downstream end 22 of the valve body 20 can also be enlarged to an extent that the integral annular wall thickness 50 has an outside diameter that is equal to or greater than the outside diameter of the receiving conduit 40.

As indicated, referring to FIGS. 1a-1c and 2, at least a portion of the valve 10 is configured to be mounted into a conduit 40. The conduit 40 may be a storm sewer, an industrial waste pipe, or any pipe which discharges an effluent into a river, creek, ocean, or analogous waterway, or a chemical reaction vessel, or any vessel known in the art where it is desired to discharge a fluid while preventing backflow into the conduit 40. As shown in FIGS. 1a-1c and 2, the valve 10 can be mounted into the conduit 40 such that a portion of the valve body 20 is positioned within the conduit 40, and the entire sleeve 30 is located in the portion of the valve body 20 positioned within the conduit 40. As such, in some non-limiting embodiments, the entire sleeve 30 is positioned within the conduit 40.

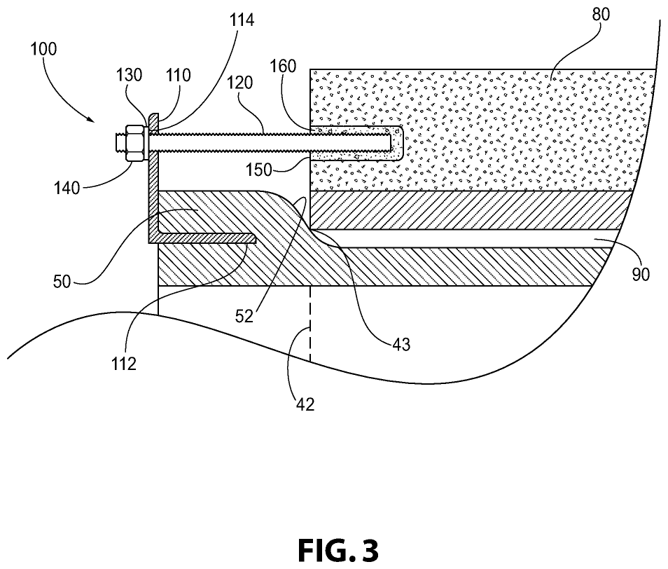

Because the enlarged integral annular wall thickness 50 has an outside diameter that is greater than at least the inside diameter of the receiving conduit 40, the enlarged integral annular wall thickness 50 can be compressed against a first end 42 of the conduit 40 to provide a leak tight seal, as shown in FIGS. 1b, 1c. 2, and 3. In certain non-limiting embodiments, as shown in FIGS. 1b, 1c, and 3, the enlarged integral annular wall thickness 50 has an inclined or angled portion on the inside portion 52. This inside portion 52 can be compressed against a first end 42 of a conduit 40 (for example, against the inside edge 43 of the first end 42 of the conduit 40) to provide the leak tight seal.

It is appreciated that the previously described enlarged integral annular wall thickness 50 can also be formed at the upstream end 24 of the valve body 20, instead of at the downstream end 22 of the valve body 20. The enlarged integral annular wall thickness 50 formed at the upstream end 24 of the valve body 20 can have any of the previously described arrangements to compress the enlarged integral annular wall thickness 50 against a second end 44 of the conduit 40 to provide a leak tight seal.

The valve body 20, including enlarged integral annular wall thickness 50, can be formed from various materials. For example, the valve body 20 can be formed from an elastomeric material.

As shown in FIGS. 1b, 1c, and 2, the remaining portion of the valve body 20 that extends from the enlarged integral annular wall thickness 50 can have an outside diameter that is less than the inside diameter of the conduit 40. The smaller outside diameter of the remaining portion of the valve body 20 that extends from the enlarged integral annular wall thickness 50 allows the remaining portion of the valve body 20 to extend into the conduit 40. Because the enlarged integral annular wall thickness 50 is compressed against the conduit 40 to provide a leak tight seal, the remaining portion of the valve body 20 can have an outside diameter that is separated from the conduit 40 to form an annular gap 90. The annular gap 90 allows for an easy and fast installation process of the check valve 10 into the conduit 40.

In certain non-limiting embodiments, and as shown in FIGS. 1-3, the check valve 10 is secured against the conduit 40 using a clamping apparatus 100, which can also help compress the enlarged integral annular wall thickness 50 against the conduit 40 to provide the leak tight seal. The clamping apparatus 100 can be used to attach or secure the check valve 10 to the conduit 40 or another component or area. For instance, the clamping apparatus 100 can be used to attach or secure the check valve 10 to a concrete wall or bulkhead 80, such as shown in FIG. 3.

Referring to FIGS. 1-3, a non-limiting example of a clamping apparatus 100 includes one or more brackets 110 (e.g. at least two, three, or four brackets 110). As shown in FIG. 3, one end 112 of each bracket 110 can be attached to at least the enlarged integral annular wall thickness 50 of the valve body 20, and a second end 114 of each bracket 110 can extend out from the enlarged integral annular wall thickness 50. As shown in FIG. 3, the second end 114 of one or more of the brackets 110, such as all of the brackets 110, can receive fasteners 120 that are further secured to holes 150 in a separate component or area, such as a concrete wall or bulkhead 80. The fasteners 120 can be threaded studs that optionally utilize washers 130 and nuts 140. A bonding material 150, such as an epoxy, may also be used to further secure the fasteners 120 to the holes 160.

It is appreciated that other clamping methods and components can also be used as the clamping apparatus 100. For instance, other non-limiting clamping methods and components that can form the clamping apparatus 100 include flexible straps, wire rope, other metal and/or plastic attaching components, and the like. As such, the clamping apparatus 100 can be formed from various types of clamping components and materials.

The previously described clamping apparatus 100 can be attached to at least the valve body 20 of the check valve 10 during formation of at least the valve body 10 or attached thereafter prior to transferring (e.g. shipping, selling, packaging, and the like) the valve 10 to a third party and/or installation site. Alternatively, the clamping apparatus 100 can be provided separately. For example, the clamping apparatus 100 and check valve 10 can be transferred (e.g. shipping, selling, packaging, and the like) as separate components as an assembly to a third party and/or installation site.

It was found that the previously described valve 10 and optional clamping apparatus 100 allow for a greater dimensional tolerance to the outside diameter of the valve body 20, inside diameter of the mating conduit 40, or both. The greater dimensional tolerance reduces manufacturing cost and allows for an easier installation process.

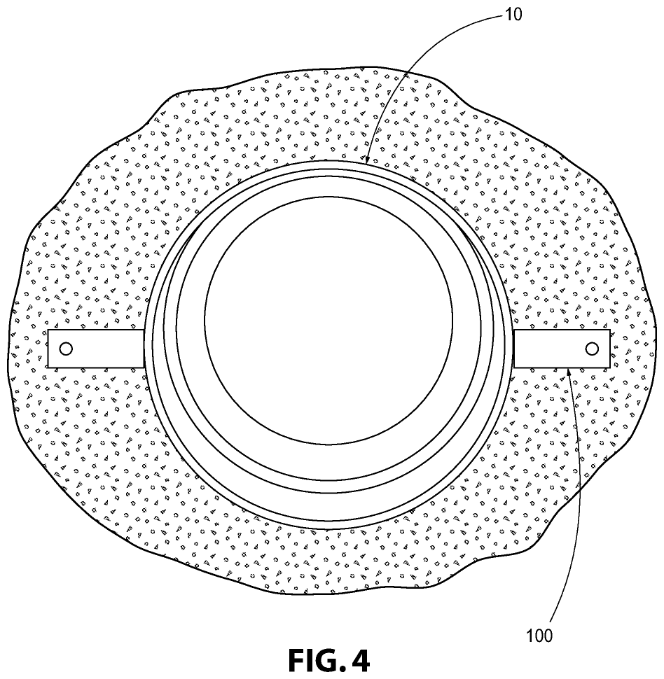

Referring to FIG. 4, it is appreciated that the present disclosure also includes a check valve 10 and a tubular sleeve 30 as previously described that uses the clamping apparatus 100, but which does not have the enlarged integral annular wall thickness 50. It will be appreciated that the check valve 10 and clamping apparatus 100 can include any of the previously described components and embodiments but without the enlarged integral annular wall thickness 50.

Whereas particular embodiments of this invention have been described above for purposes of illustration, it will be evident to those skilled in the art that numerous variations of the details of the present invention may be made without departing from the invention.

The invention claimed is:

1. A check valve comprising:
(a) a tubular valve body comprising a downstream end and an upstream end; and
(b) a tubular sleeve positioned within the tubular valve body, the tubular sleeve bounding a longitudinally-extending flow-through passage for fluids, said sleeve having an upstream fluid inlet region and a downstream fluid outlet region,
wherein the downstream end or upstream end of the tubular valve body comprises an enlarged integral annular wall thickness having an outside diameter that is greater than an outside diameter of remaining portions of the tubular valve body.

2. The check valve according to claim 1, wherein the enlarged integral annular wall thickness is configured to compress against and form a leak tight seal with a first or second end of a receiving conduit, and the remaining portions of the tubular valve body are configured to extend into the receiving conduit

3. The check valve according to claim 1, wherein the enlarged integral annular wall thickness has an inclined or angled shape on an inside portion.

4. The check valve according to claim 2, wherein the remaining portions of the tubular valve body extending from the enlarged integral annular wall thickness have an outside diameter that is sized to form an annular gap between the tubular valve body and the receiving conduit.

5. The check valve according to claim 1, further comprising a clamping apparatus that secures the check valve to a separate component or area.

6. The check valve according to claim 5, wherein the clamping apparatus comprises one or more brackets having a first end that attaches to the tubular valve body and a second end that is secured to the separate component or area.

7. The check valve according to claim 1, wherein the downstream fluid outlet region of said sleeve is integrally formed with a longitudinally-extending trough, said trough having a bottom wall and a pair of side walls integral with said bottom wall, said trough formed with said downstream fluid outlet region of said sleeve so as to provide a flow-through passage.

8. The check valve according to claim 7, further comprising a disc comprising a first material affixed along a first portion of its periphery to a flexible hinge member, said flexible hinge member affixed to and interposed between said disc and said downstream fluid outlet region of said sleeve, and wherein a second portion of the periphery of said disc opposite said first portion rests within said trough on said bottom wall of said trough when said valve is in a closed position, wherein said disc opens said valve in response to positive differential pressure within said valve.

9. The check valve according to claim 8, further comprising a bill affixed at a first end to one or more of the group consisting of the sleeve, the flexible hinge member, and the disc, said bill extending longitudinally downstream along a longitudinal axis of said trough, said bill being integrally formed with said side walls of said trough, said bill being formed of a flexible material and forming an opening for discharge of fluid in response to a positive differential pressure within said valve from said fluid, and said bill forming a seal to prevent backflow of said fluid through said valve when no differential pressure or negative differential pressure is present.

10. The check valve according to claim 1, wherein the downstream end of the tubular valve body comprises the enlarged integral annular wall thickness.

11. A fluid control system comprising:
(1) a check valve comprising:
(a) a tubular valve body comprising a downstream end and an upstream end; and
(b) a tubular sleeve positioned within the valve body, the tubular sleeve bounding a longitudinally-extending flow-through passage for fluids, said sleeve having an upstream fluid inlet region and a downstream fluid outlet region,
wherein the downstream end or upstream end of the tubular valve body comprises an enlarged integral annular wall thickness having an outside diameter that is greater than an outside diameter of remaining portions of the tubular valve body; and
(2) a receiving conduit;
wherein the enlarged integral annular wall thickness of the tubular valve body has an outside diameter that is greater than at least an inside diameter of the receiving conduit, and the remaining portions of the tubular valve body extending from the enlarged integral annular wall thickness have an outside diameter that is less than the inside diameter of the receiving conduit, and
wherein the enlarged integral annular wall thickness of the tubular valve body is compressed against and forms a leak tight seal with a first or second end of the receiving conduit, and the remaining portions of the tubular valve body extend into the receiving conduit.

12. The fluid control system according to claim 11, wherein the enlarged integral annular wall thickness has an inclined or angled shape on an inside portion that compresses against and forms the leak tight seal with the first or second end of the receiving conduit.

13. The fluid control system according to claim 11, wherein an annular gap is formed between the receiving conduit and the remaining portions of the tubular valve body extending into the receiving conduit.

14. The fluid control system according to claim 11, further comprising a clamping apparatus that secures the check valve to a separate component or area.

15. The fluid control system according to claim 14, wherein the clamping apparatus comprises one or more brackets having a first end that attaches to the tubular valve body and a second end that is secured to the separate component or area.

16. The fluid control system according to claim 11, wherein the downstream fluid outlet region of said sleeve is integrally formed with a longitudinally-extending trough, said trough having a bottom wall and a pair of side walls integral with said bottom wall, said trough formed with said downstream fluid outlet region of said sleeve so as to provide a flow-through passage.

17. The fluid control system according to claim 16, where the check valve further comprises a disc comprising a first material affixed along a first portion of its periphery to a flexible hinge member, said flexible hinge member affixed to and interposed between said disc and said downstream fluid outlet region of said sleeve, and wherein a second portion of the periphery of said disc opposite said first portion rests within said trough on said bottom wall of said trough when said valve is in a closed position, wherein said disc opens said valve in response to positive differential pressure within said valve, and
a bill affixed at a first end to one or more of the group consisting of the sleeve, the flexible hinge member, and the disc, said bill extending longitudinally downstream along a longitudinal axis of said trough, said bill being integrally formed with said side walls of said trough, said bill being formed of a flexible material and forming an opening for discharge of fluid in response to a positive differential pressure within said valve from said fluid, and said bill forming a seal to prevent backflow of said fluid through said valve when no differential pressure or negative differential pressure is present.

18. A check valve assembly comprising:
(i) the check valve according to claim 1; and
(ii) a clamping apparatus that secures the check valve to a separate component or area.

19. A method of forming a fluid control system comprising:
(i) inserting a check valve into a receiving conduit, the check valve comprising:
(a) a tubular valve body comprising a downstream end and an upstream end; and
(b) a tubular sleeve positioned within the valve body, the tubular sleeve bounding a longitudinally-extending flow-through passage for fluids, said sleeve having an upstream fluid inlet region and a downstream fluid outlet region,
wherein the downstream end or upstream end of the tubular valve body comprises an enlarged integral annular wall thickness having an outside diameter that is greater than an outside diameter of remaining portions of the tubular valve body; and
(ii) compressing the enlarged integral annular wall thickness of the tubular valve body against a first or second end of the receiving conduit to form a leak tight seal, wherein the remaining portions of the tubular valve body extend into the receiving conduit.

20. The method according to claim 19, further comprising securing the check valve to a separate component or area with a clamping apparatus.
